(19) United States
(12) Patent Application Publication
(10) Pub. No.: US 2012/0167890 A1
(43) Pub. Date: Jul. 5, 2012

(54) RESPIRATOR HAVING VALVE WITH AN ABLATED FLAP

(75) Inventors: Thomas I. Insley, Lake Elmo, MN (US); Thomas J. Xue, St. Paul, MN (US)

(73) Assignee: 3M Innovative Properties Company

(21) Appl. No.: 13/323,130

(22) Filed: Dec. 12, 2011

Related U.S. Application Data
(60) Provisional application No. 61/427,882, filed on Dec. 29, 2010.

(51) Int. Cl. A62B 18/10; A62B 27/00; B23P 17/00

(52) U.S. Cl. 128/206.15; 29/428; 29/407.01

(57) ABSTRACT

A respirator 10 that has a mask body 12, a harness 13, and an exhalation valve 14. Both the harness 13 and the exhalation valve 14 are secured to the mask body 12. The exhalation valve 14 comprises a valve seat 20 and a flap 22 that has a surface 57 that has been ablated. Through use of an ablated flap, the flap characteristics can be better fashioned to achieve desired valve performance. The valve flap can be fashioned to remain closed under any orientation but also to open with minimal force or pressure from the wearer's exhaled air. A valve having these qualities provides a respirator that is more comfortable for a person to wear, which can be particularly beneficial to workers who wear respirators for extended time periods.

### CROSS REFERENCE TO RELATED APPLICATION

This application claims the benefit of U.S. Provisional Patent Application Ser. No. 61/427,882, filed Dec. 29, 2010.

The present invention pertains to a respirator having an exhalation valve that uses a flap that has one or more ablated areas.

### BACKGROUND

Persons who work in polluted environments commonly wear respirators to protect themselves from inhaling airborne contaminants. Respirators typically have a fibrous or sorbent filter that is capable of removing particulate and/or gaseous contaminants from the air. When wearing a respirator in a contaminated environment, wearers are comforted with the knowledge that their health is being protected, but they are, however, contemporaneously discomforted by the warm, moist, exhaled air that accumulates around their face. The greater this facial discomfort is, the greater chances are that the wearer will remove the mask from their face to alleviate the unpleasant condition.

To reduce the likelihood that a wearer will remove the mask from their face in a contaminated environment, respirator manufacturers often install an exhalation valve on the mask body to allow the warm, moist, air to be rapidly purged from the mask interior. The rapid removal of the exhaled air makes the mask interior cooler, and, in turn, benefits worker safety because mask wearers are less likely to remove the respirator from their face to eliminate the hot moist environment that is located around their nose and mouth.

For many years, commercial respiratory masks have used “button-style” exhalation valves to purge exhaled air from mask interiors. The button-style valves typically have employed a thin circular flexible flap as the dynamic mechanical element that lets exhaled air escape from the interior gas space. The flap is centrally mounted to a valve seat through a central post. Examples of button-style valves are shown in U.S. Pat. Nos. 2,072,516, 2,230,770, 2,895,472, and 4,630,604. When a person exhales, a circumferential portion of the flap is lifted from the valve seat so that the air can rapidly pass into the exterior gas space.

Button-style valves have represented an advance in the attempt to improve wearer comfort, but investigators have made other improvements, an example of which is the “butterfly-style” valve shown in U.S. Pat. No. 4,934,362 to Braun. The valve described in this patent uses a parabolic valve seat and an elongated flexible flap mounted in butterfly fashion.

After the Braun development, another innovation was made in the exhalation valve art by Japuntich et al.—see U.S. Pat. Nos. 5,325,892 and 5,509,436. The Japuntich et al. valve uses a single flexible flap that is mounted off-center in cantilevered fashion to minimize the exhalation pressure that is required to open the valve. When the valve-opening pressure is minimized, less power is required to operate the valve, which means that the wearer does not need to work as hard to expel exhaled air from the mask interior when breathing.

Other valves that have been introduced after the Japuntich et al. valve also have used cantilevered mounted flaps—see U.S. Pat. Nos. 5,687,767 and 6,047,698. In yet another development, the seal surface of the valve seat has been made of a resilient material to allow a more rigid, yet stiffer flap to be used, which improved the valve efficiency—see U.S. Pat. No. 7,188,622 to Martin et al.

Although the evolution of exhalation valve design has been centered mainly around structural changes relative to the valve seat and the mounting of the flap to it, investigators also have made structural changes to the flap itself to improve valve performance. In U.S. Pat. No. 7,028,689 to Martin et al., multiple layers were introduced into the flap to enable a thinner, more dynamic flap to be used, which allowed the valve to open easier under less pressure drop. And in U.S. Patent Application 2009/0133700 to Martin et al., slots were provided in the valve flap at the hinge to improve valve performance.

### SUMMARY OF THE INVENTION

The present invention provides a new respirator that comprises a mask body, a harness, and an exhalation valve. Both the harness and the exhalation valve are secured to the mask body. The exhalation valve comprises a valve base and a flap that has a surface that has been ablated.

The present invention also provides new a method of making a respirator, which method comprises the steps of: providing a valve base and a mask body; securing an ablated flap to the valve base; and securing the valve base to the mask body.

The provision of an ablated flap is beneficial in that the flap can be tailored to have characteristics in stiffness and thickness at specifically desired areas on the flap, which specifically tailored areas can enable the flap to open with minimal force or can alter a particular valve attribute in a desired manner. A valve that can open continuously under minimal force, with little pressure drop across the valve, requires less energy to operate. Since the wearer is the power source for operating the valve, the wearer does not need to work as hard when wearing a respirator where the valve exhibits optimal performance. Improved valve performance, in turn, can make respirators more comfortable to wear over extended time periods, which is particularly beneficial from a safety standpoint, since wearers are less likely to remove the mask from their face in contaminated environments.

The present invention also may be beneficial from a manufacturing standpoint since individual flaps can be tailored during product manufacture to satisfy specific quality control/performance requirements. By ablating certain flap portions during valve assembly, less products may be rejected for failing to meet desired performance requirements during the quality control assessment.

### GLOSSARY

The terms set forth below will have the meanings as defined:

“ablation” or “ablated” means having a portion(s) removed from the surface so as to not cut completely though;

“clean air” means a volume of atmospheric ambient air that has been filtered to remove contaminants;

“comprises (or comprising)” means its definition as is standard in patent terminology, being an open-ended term that is generally synonymous with “includes”, “having”, or “containing”. Although “comprises”, “includes”, “having”, and “containing” and variations thereof are commonly-used, open-ended terms, this invention also may be suitably described using narrower terms such as “consists essentially of”, which is semi open-ended term in that it excludes only those things or elements that would have a deleterious effect on the performance of the subject matter to which the term pertains;

“exhalation valve” means a valve that opens to allow exhaled air to exit a filtering face mask's interior gas space;

“exhaled air” is air that is exhaled by a respirator wearer;

“exterior gas space” means the ambient atmospheric gas space into which exhaled gas enters after passing through and beyond the mask body and/or exhalation valve;

“filter” or “filtration layer” means one or more layers of material, which layer(s) is adapted for the primary purpose of removing contaminants (such as particles) from an air stream that passes through it;

“filter media” means an air-permeable structure that is designed to remove contaminants from air that passes through it;

“flap” means a sheet-like article that is designed to open and close during valve operation;

“flexible flap” means a sheet-like article that is capable of bending or flexing in response to a force exerted from an exhale gas stream;

“harness” means a structure or combination of parts that assists in supporting the mask body on a wearer's face;

“interior gas space” means the space between a mask body and a person's face;

“laser” means a device that provides a highly directional monochromatic and coherent beam of light;

“mask body” means an air-permeable structure that can fit at least over the nose and mouth of a person and that helps define an interior gas space separated from an exterior gas space;

“multiple” means more than 5;

“plurality” means two or more;

“respirator” means a device that is worn by a person to filter air before the air enters the interior gas space; and

“valve seat” or “valve base” means the solid part of a valve which has an orifice for a fluid to pass through and which is disposed adjacent to or in contact with the substrate or article to which it is mounted.

### BRIEF DESCRIPTION OF THE DRAWINGS

In the drawings:

FIG. 1 is a front view of a respirator 10 that has a mask body 12 onto which an exhalation valve 14, having an ablated flap 22 in accordance with the present invention, is disposed;

FIG. 2 is a cross-sectional side view of the exhalation valve 14 of FIG. 1;

FIG. 3 is a front view of a valve base 20 for the valve 14 shown in FIG. 2;

FIG. 4 is a cross-sectional side view of an alternative embodiment of an exhalation valve 14′ in accordance with the present invention;

FIG. 5 is a front view of a valve base 20b for a button-style exhalation valve;

FIG. 6 is a perspective view of a valve cover 40 that may be used with an exhalation valve in accordance with the present invention;

FIG. 7a is a enlarged perspective view of the flap 22 used in with the valve or valve base shown in FIGS. 1-4;

FIG. 7b is a perspective view of an alternative embodiment of an ablated flap 44 suitable for use in connection with the present invention;

FIG. 8 is a front view of an ablated flap 60 that could be used in connection with a button style valve in accordance with the present invention;

FIG. 9 is a front view of an ablated flap 74 that could be used in connection with a button or butterfly style valve in accordance with the present invention;

FIG. 10 is a perspective view of another embodiment of an ablated flap 76 that may be used in connection with a cantilevered valve according to the present invention;

FIG. 11 is a front view of another embodiment of an ablated flap 76 that could be used in connection with a button style valve in accordance with the present invention;

FIG. 12 is a schematic view of a process for cutting and assembling flaps according to the present invention;

FIG. 13 illustrates a method of ablating flaps in a quality control process in accordance with the present invention; and

FIG. 14 is a cross-section of a mask body 12 in accordance with the present invention.

### DETAILED DESCRIPTION OF PREFERRED EMBODIMENTS

In the practice of the present invention, a new filtering face mask is provided that may improve wearer comfort and concomitantly make it more likely that users will continuously wear their masks in contaminated environments. The present invention thus may improve worker safety and provide long term health benefits to workers and others who wear personal respiratory protection devices.

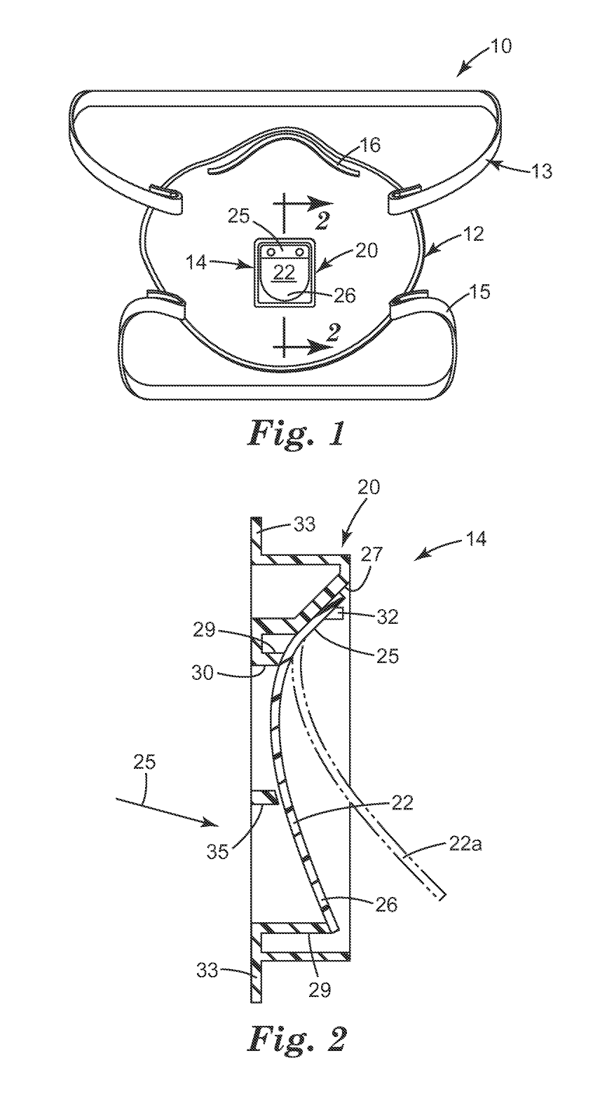

FIG. 1 illustrates an example of a filtering face mask 10 that may be used in conjunction with the present invention. Filtering face mask 10 is a half mask (because it covers the nose and mouth but not the eyes) that has a cup-shaped mask body 12 onto which a harness 13 and an exhalation valve 14 are attached. The exhalation valve can be secured to the mask body 12 using a variety of techniques such as ultrasonic welding, gluing, adhesively bonding (see U.S. Pat. No. 6,125,849 to Williams et al.), or mechanical clamping (see U.S. Patent Application 2001/0029952A1). The exhalation valve 14 opens in response to increased pressure inside the mask 10, which increased pressure occurs when a wearer exhales. The exhalation valve 14 preferably remains closed between breaths and during an inhalation. To hold the face mask snugly upon the wearer's face, the harness 13 can include straps 15, tie strings, or any other suitable means attached to it for supporting the mask body 12 on the wearer's face. Examples of mask harnesses that may be used in connection with the present invention are shown in U.S. Pat. Nos. 6,457,473B1, 6,062,221, and 5,394,568, and to Brostrom et al., U.S. Pat. No. 6,332,465B1 to Xue et al., U.S. Pat. Nos. 6,119,692 and 5,464,010 to Byram, and U.S. Pat. Nos. 6,095,143 and 5,819,731 to Dyrud et al.

FIG. 1 further shows that the valve 14 has a valve seat 20 onto which a flap 22 is secured at stationary portion 25. The flap 22 can be a flexible flap that has a free portion 26 that lifts from the valve seat 20 during an exhalation. When the free portion 26 is not in contact with the valve seat 20, exhaled air may pass from the interior gas space to an exterior gas space. The exhaled air may pass directly into the exterior gas space, or it may take a more tortuous path if, for example, the mask also includes an impactor element (see U.S. Pat. No. 6,460,539 B1 to Japuntich et al.) or it includes a filtered exhalation valve (see U.S. Patent Applications 2003/0005934A1 and U.S. Patent Application 2002/0023651A1 to Japuntich et al.).

Mask body 12 is adapted to fit over the nose and mouth of a person in spaced relation to the wearer's face to create an interior gas space or void between the wearer's face and the interior surface of the mask body. A nose clip 16 that comprises a pliable dead soft band of metal such as aluminum can be placed on mask body 12 to allow it to be shaped to hold the face mask in a desired fitting relationship over the nose of the wearer and where the nose meets the cheek. An example of a suitable nose clip is shown in U.S. Pat. Nos. 5,558,089 and Des. 412,573 to Castiglione. The illustrated mask body 12 is fluid permeable and typically is provided with an opening (not shown) that is located where the exhalation valve 14 is attached to the mask body 12 so that exhaled air can exit the interior gas space through the valve 14 without having to pass through the mask body itself. The preferred location of the opening on the mask body 12 is directly in front of where the wearer's mouth would be when the mask is being worn. The placement of the opening, and hence the exhalation valve 14, at this location allows the valve to open more easily in response to the force or momentum from the exhale flow stream. For a mask body 12 of the type shown in FIG. 1, essentially the entire exposed surface of mask body 12 is fluid permeable to inhaled air.

Mask body 12 can have a curved, hemispherical shape as shown in FIG. 1 (see also U.S. Pat. No. 4,807,619 to Dyrud et al.), or it may take on other shapes as so desired. For example, the mask body can be a cup-shaped mask having a construction like the face mask disclosed in U.S. Pat. No. 4,827,924 to Japuntich. The mask also could have the three-fold configuration that can fold flat when not in use but can open into a cup-shaped configuration when worn—see U.S. Pat. Nos. 6,484,722B2 and 6,123,077 to Bostock et al., and U.S. Design Patents Des. 431,647 to Henderson et al., and Des. 424,688 to Bryant et al. Face masks of the invention also may take on many other configurations, such as flat bifold masks disclosed in U.S. Design Patents Des. 448,472S and Des. 443,927S to Chen. The mask body also could be fluid impermeable and could have filter cartridges attached to it like, for example, the masks shown in U.S. Pat. No. 6,277,178B1 to Holmquist-Brown et al. or in U.S. Pat. No. 5,062,421 to Burns and Reischel. In addition, the mask body also could be adapted for use with a positive pressure air intake as opposed to the negative pressure masks just mentioned. Examples of positive pressure masks are shown in U.S. Pat. Nos. 6,186,140 B1 to Hoague, 5,924,420 to Grannis et al., and 4,790,306 to Braun et al. These masks may be connected to a powered air purifying respirator body that would be worn around the waist of the user—see, e.g., U.S. Design Patent D464,725 to Petherbridge et al. The mask body of the filtering face mask also could be connected to a self-contained breathing apparatus, which may supply clean air to the wearer as disclosed, for example, in U.S. Pat. Nos. 5,035,239 and 4,971,052. The mask body may be configured to cover not only the nose and mouth of a wearer (referred to as a “half mask”) but may also cover the eyes as well (referred to as a “full face mask”) to provide protection to a wearer's vision in addition to the wearer's respiratory system—see, for example, U.S. Pat. No. 5,924,420 to Reischel et al.

The mask body may be spaced from the wearer's face, or it may reside flush or in close proximity to it. In either instance, the mask helps define an interior gas space into which exhaled air passes before leaving the mask interior through the exhalation valve. The mask body also could have a thermochromic fit-indicating seal at its periphery to allow the wearer to easily ascertain if a proper fit has been established—see U.S. Pat. No. 5,617,849 to Springett et al.

FIG. 2 shows the flexible flap 22 in a closed position, resting on seal surface 24, and in an open position, lifted away from surface 24 as represented by dotted line 22a. A fluid passes through the valve 14 in the general direction indicated by arrow 34. If valve 14 is used on a filtering face mask to purge exhaled air from the mask interior, fluid flow 34 would represent an exhale flow stream. If valve 14 was used as an inhalation valve, flow stream 34 would represent an inhale flow stream. The fluid that passes through the valve orifice exerts a force on the flexible flap 22 (or transfers its momentum to it), causing the free portion 26 of flap 22 to be lifted from seal surface 24 to make the valve 14 open. When the valve 14 is used as an exhalation valve, the valve is preferably oriented on face mask 10 such that the free portion 26 of flexible flap 22 is located below the stationary portion 25 when the mask 10 is positioned upright as shown in FIG. 1. This enables exhaled air to be deflected downwards to prevent moisture from condensing on the wearer's eyewear.

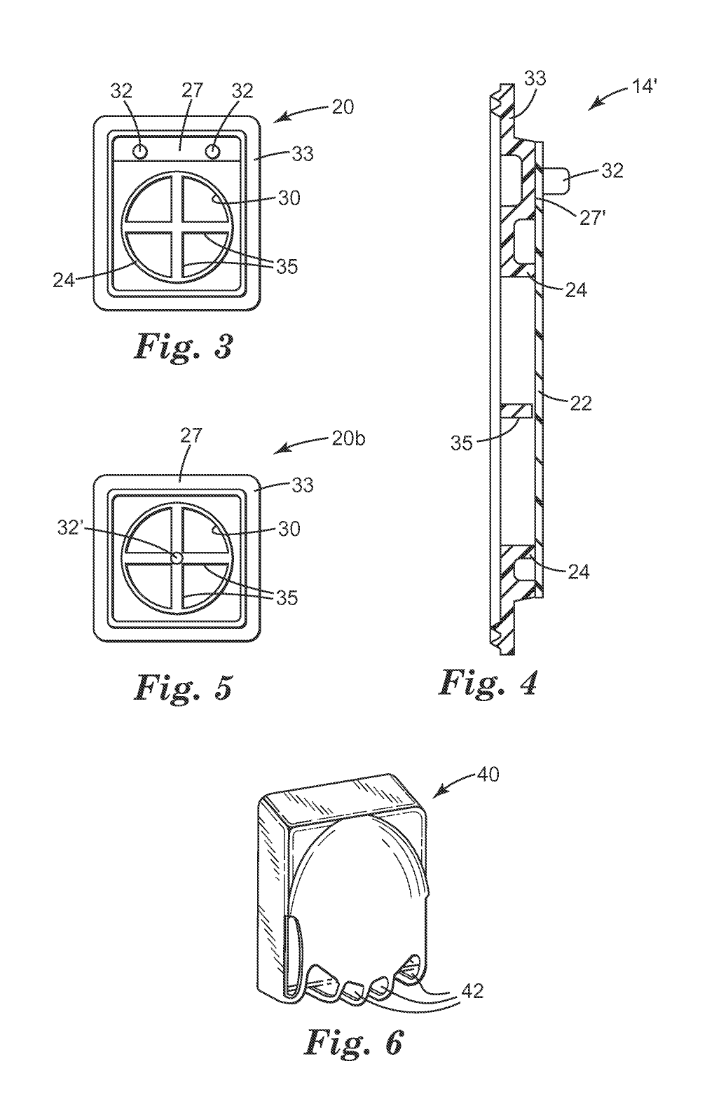

FIG. 3 shows the valve seat 20 from a front view without a flap being attached to it. The valve orifice 30 is disposed radially inward from the seal surface 24 and can have cross members 35 that stabilize the seal surface 24 and ultimately the valve 14. The cross members 35 also can prevent flexible flap 22 (FIG. 2) from inverting into the orifice 30 during an inhalation. Moisture build-up on the cross members 35 can hamper the opening of the flap 22. Therefore, the surfaces of the cross-members 35 that face the flap preferably are slightly recessed beneath the seal surface 24, but they may be flush with the seal surface when viewed from a side elevation to avoid hampering valve opening.

The seal surface 24 circumscribes or surrounds the orifice 30 to preclude passage of contaminates through the orifice when the valve is closed. Seal surface 24 and the valve orifice 30 can take on essentially any shape when viewed from the front. For example, the seal surface 24 and the orifice 30 may be square, rectangular, circular, elliptical, etc. The shape of seal surface 24 does not have to correspond to the shape of orifice 30 or vise versa. For example, the orifice 30 may be circular and the seal surface 24 may be rectangular. The seal surface 24 and orifice 30, however, preferably have a circular cross-section when viewed against the direction of fluid flow.

The majority of the valve seat 20 is typically made from a relatively lightweight plastic that is molded into an integral one-piece body using, for example, injection molding techniques and the resilient seal surface would be joined to it. The seal surface 24 that makes contact with the flexible flap 22 is preferably fashioned to be substantially uniformly smooth to ensure that a good seal occurs. The seal surface 24 may reside on the top of a seal ridge 29 (FIG. 2) or it may be in planar alignment with the valve seat itself. The contact area of the seal surface 24 preferably has a width great enough to form a seal with the flexible flap 22 but is not so wide as to allow adhesive forces—caused by condensed moisture or expelled saliva—make the flexible flap 22 significantly more difficult to open. The contact area of the seal surface preferably is curved in a concave manner where the flap makes contact with the seal surface to facilitate contact of the flap to the seal surface around the whole perimeter of the seal surface. The valve 14 and its valve seat 20, without the resilient seal surface, are more fully described in U.S. Pat. Nos. 5,509,436 and 5,325,892 to Japuntich et al.

FIG. 4 shows another embodiment of an exhalation valve 14′. Unlike the embodiment shown in FIG. 2, this exhalation valve has, when viewed from a side elevation, a planar seal surface 24′ that is in alignment with the flap-retaining surface 27′. The flap shown in FIG. 4 thus is not pressed towards or against the seal surface 24′ by virtue of any mechanical force or internal stress that is placed on the flexible flap 22. Because the flap 22 is not preloaded or biased towards the seal surface 24′ under “neutral conditions”—that is, when no fluid is passing through the valve and the flap is not otherwise subjected to external forces other than gravity—the flap 22 can open more easily during an exhalation. When using a resilient seal surface in accordance with the present invention, it may not be necessary to have the flap biased or forced into contact with the seal surface 24′—although such a construction may be desired in some instances. The invention thus may allow for the use of a flexible flap that is stiffer than flaps on known commercial products. The flap may be so stiff that it does not significantly droop away from the seal surface 24′ in an unbiased condition when the force of gravity is per se exerted upon the flap and the valve is oriented such that the flap is disposed below the seal surface. The exhalation valve 14′ shown in FIG. 5 therefore can be fashioned so that the flap 22 makes good contact with the seal surface under any orientation, including when a wearer bends their head downward towards the floor, without having the flap biased (or substantially biased) towards the seal surface. A stiff flap, therefore, may make hermetic-type contact with the seal surface 24′ under any orientation of the valve with very little or no pre-stress or bias towards the valve seat's seal surface. The lack of significant predefined stress or force on the flap, to ensure that it is pressed against the seal surface during valve closure under neutral conditions, can enable the flap to open more easily during an exhalation and hence can reduce the power needed to operate the valve while breathing.

FIG. 5 shows a valve seat 20b that is suitable for use in connection with button valves of the present invention. Unlike the valve seat 20 (FIG. 3) that is fashioned for use in connection with cantilevered valve flaps, the valve seat 20b has the flexible flap mounted centrally at location 32′. This enables essentially any portion of the perimeter of the flap to be lifted from the seal surface during an exhalation. In cantilevered flaps, the end of the flap that is opposite the stationary portion is the part of the flap that lifts from the seal surface during an exhalation. In contrast, in a button-style valve any portion of that circumference may be lifted from the seal surface during an exhalation. In conventional button-style valves, the whole valve flap was configured to have essentially the same thickness. This caused the flap to form resistance areas during an exhalation since not all portions of the circumference could be lifted from the valve flap during an exhalation. As is described below, flaps of the present invention, when used in conjunction with a button-style valve, can have selected areas ablated from the valve flap surface to create thinner and thicker areas so that the flap selectively bends at certain portions or areas. As such, using ablation techniques in connection with the centrally-mounted button flap, the resistance to opening may be lessened. This can create lower pressure drops and hence improve wearer comfort.

FIG. 6 shows a valve cover 40 that may be suitable for use in connection with the exhalation valves shown in the other figures. The valve cover 40 defines an internal chamber into which the flexible flap can move from its closed position to its open position. The valve cover 40 can protect the flexible flap from damage and can assist in directing exhaled air downward away from a wearer's eyeglasses. As shown, the valve cover 40 may possess a plurality of openings 42 to allow exhaled air to escape from the internal chamber defined by the valve cover. Air that exits the internal chamber through the openings 42 enters the exterior gas space, preferably, downwardly away from a wearer's eyewear. The valve cover can be secured to the valve seat using a variety of techniques including friction, clamping, gluing, adhesively bonding, welding, etc.

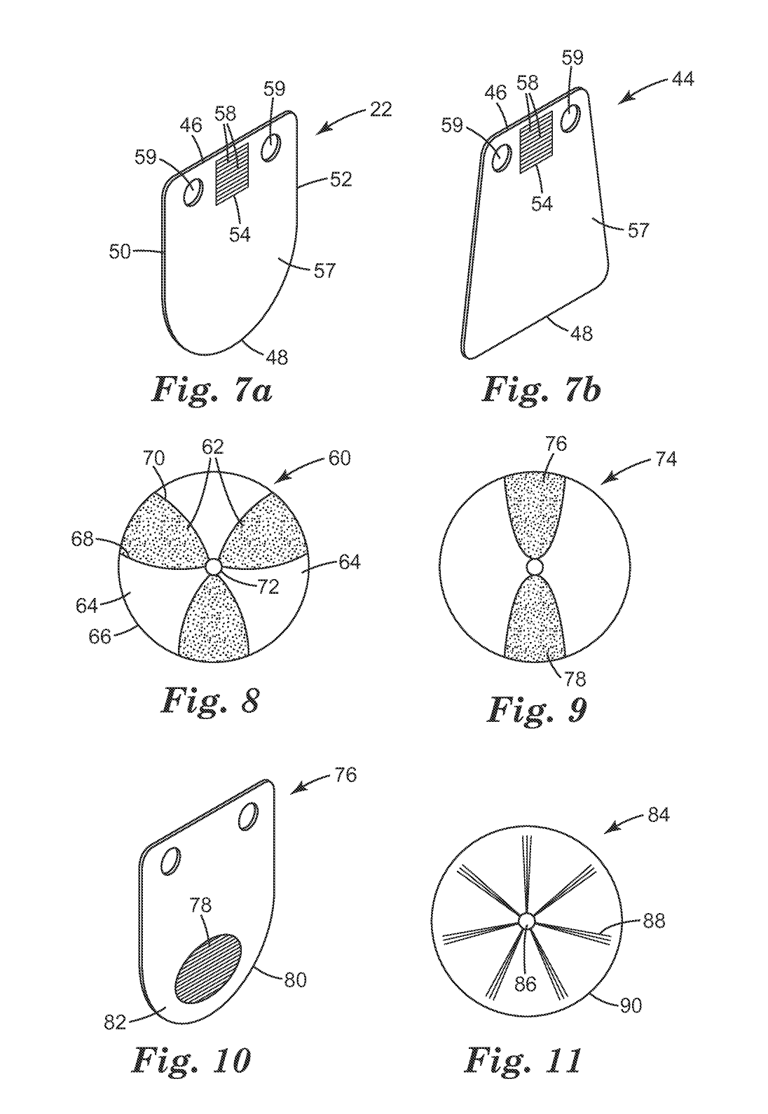

FIG. 7a shows a valve flap 22 that has first and second opposing ends 46 and 48 and first and second opposing sides 50 and 52. The flap 22 has a rectangular shape to it, while the flap 44 shown in FIG. 7b has a trapezoidal shape to it. The flap 22, 44 also includes an ablated area 54, which is located in the hinge region 56 of the flap. The flap shown in FIG. 7b may be used to reduce the material exposed to the bending moment of the flap due to the momentum of the exhale flow stream. The ablated area 54 includes multiple grooves 58 that have been cut into the first major surface 57 of the flap material. The grooves 58 are cut parallel to the axis about which the flap bends, pivots, or rotates during opening or closing. The grooves each are about 10 to 90% of the flap thickness, more typically 20 to 70% of the total flap thickness and have a length of about 5 to 15 mm. For an exhalation valve, the grooves may be about 0.1 to 1 millimeters (mm) deep, more commonly 0.2 to 0.4 mm deep. The grooves may be spaced about 0.1 to 1 mm, more typically 0.2 to 0.3 mm. As with other embodiments of an ablated flap described in this document, one or both major surfaces of the flap may be ablated. Anchoring holes 59 are provided at the hinge end 46 of the flap 22, 44.

FIG. 8 shows a circular flap 60 that is suitable for use in conjunction with a button-style valve seat (see FIG. 5). This flap 60 also has ablated 62 and unablated 64 areas. When a conventional button-style valve opens, the radial nature of the valve causes the flap to resist opening around its whole circumference 66. Thus, only a portion or segment of the flap 60 tends to lift from the seal surface during use. The flap 60 illustrated here may alleviate this “resistance to opening issue”. The ablated areas 62 of the flap 60 have less material and thus encourage bending in those areas, which may enable the whole circumference 66 of the flap to be lifted from the seal surface during use. The ablated areas 62 are bounded on each side by borders 68 and 70 which move away from each other as they progress from the center 72 to the circumference 66 of the flap 60. The ablated areas may occupy about 5 to 80% of the total surface area of one of the major surfaces of the flap and may generally extend radially outward 120° to each other.

FIG. 9 shows a centrally mounted valve flap 74 where the ablated areas 76, 78 extend toward the circumference in opposite directions; that is, 180 degrees to each other. The ablated areas thus extend linearly across the flap 74 in a straight line. This encourages bending of the flap about an axis parallel to the extended direction of the ablated area. Using such an ablated arrangement, the valve flap 74 may bend in butterfly fashion during use. In this embodiment, the valve flap 74 does not need to be circular; it can be longer in the direction normal to the extended direction of ablated area in the plane of the major surface of the flap 74 when at rest. The ablated area may be about 10 to 90% of the flexural length of the flap and about 5 to 80% of the radial length.

FIG. 10 shows yet another embodiment of a flap 76 which may be used in connection with a valve of the present invention. In this instance the ablated area is not located in what is intended to be a hinge region of the flap. Rather, the ablated area 78 is located centrally on the free portion 80 of the flap in spaced relation to the stationary portion 80. Since this free part of the flap 76 only needs to have sufficient thickness to remain fluid impermeable, the weight of the flap in the free portion may be substantially reduced. which can enable the flap to open with less force (since there is less weight to displace). As shown in the figure, the ablated area 78 is bounded by a non-ablated edge region 82. The increased thickness along the non-ablated edge region may enable the flap to better engage the valve seal surface, which resides beneath or adjacent this part of the flap 76. Ablation also could be carried out on the underside or second major surface of the flap where the flap contacts the seal surface to create a flap that seats upon the seal surface like a lid with step. Such an ablation would create a groove on the second major surface, which groove follows or corresponds to the path or configuration of the seal surface so that there is a complementary mating between the two parts.

FIG. 11 shows another embodiment of a flap 84 for a button valve where the ablated regions extend radially from the center 86 in equally spaced distances. There are multiple ablated regions that have a generally constant thickness. The ablated regions each may be fashioned with grooves 88 that extend in a straight line from the center 86 to the circumference 90. Each of the grooves 88 may have a depth and thickness similar to the grooves references elsewhere in this document.

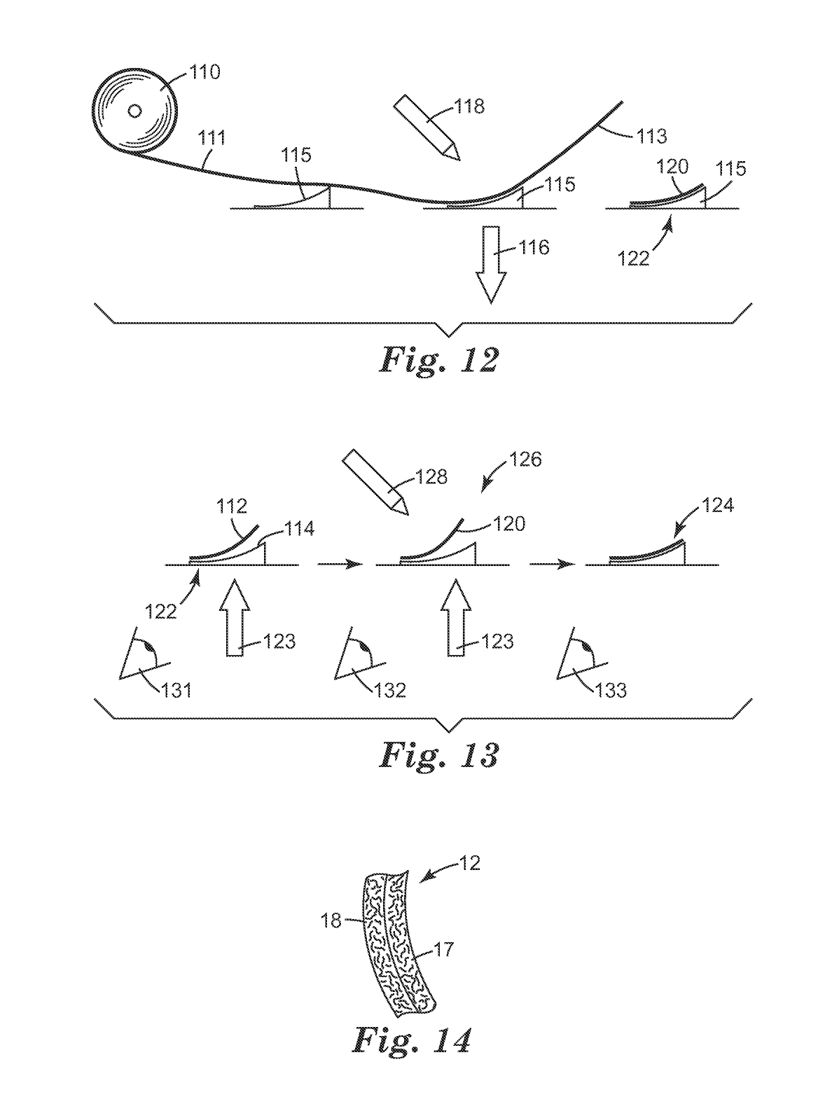

An automated method employed laser cutting and ablation may be used to assemble and performance certify flap valve assemblies of the present invention. FIGS. 12 and 13 illustrate a succession of steps that might be beneficially employed when very consistent valve performance is required in the final product, such as in respiratory protection. While FIG. 12 illustrates an in-line approach to the method, steps might also be carried out on rotary or turret equipment. Regardless of the general component orientation or equipment used within the method, two basic stages are shown: assembly and certification.

In FIG. 12 a continuous strip of valve flap material 111 is unwound from a role 110 and is conveyed to a valve seat 115. The valve seat 115 is introduced to a continuous strip 111 of flap material with the valve seat 115 and flap material 111 traveling at the same rate. A vacuum source 116 is used to draw the flap strip 111 to the valve seat 115 to hold it in proper registration. With the strip of valve flap material 111 and valve seat 115 in proper orientation, a laser 118 is used to precisely cut a flap 120 from the strip 111 to enable the now separated flap 120 to be positioned on the valve seat 115. The laser 118 may additionally cut any anchoring and/or alignment holes in the flap 120 at this stage. The valve flap 120 is then be affixed to the valve seat 115 in proper position. The drawing force from the vacuum 116 may be removed. As the valve assembly progresses to the next station 117, the unused portion of the flap strip material 113 is separated from the valve assembly 122. Additionally at this stage, a protective valve cover can be affixed to the valve assembly.

In FIG. 13, actuation performance of the valve 122 is evaluated and adjusted using laser ablation. A valve certification stage assesses the actuation characteristics of a valve and adjusts that actuation using further laser ablation. Ablation may be carried out at the hinge portion or free portion of the flap as necessary to achieve desired valve actuation. An assembled valve may move through a succession of evaluation, modification, and confirmation steps. In a first step, the assembled valve 122 is challenged with a fluid flow 123 at a controlled volumetric rate. Flap actuation is then monitored at 131 using for example, machine vision (optical monitoring with computer interpretation) to determine the valve response to the fluid flow challenge. The response to the challenge may be analyzed using a computer algorithm and may be compared against a model actuation. As the valve assembly moves to the next stage 126, the computer then facilitates a controlled ablation of the valve flap 120 using a linked laser 128. The machine vision 132 at the second stage, 126 assesses the flap actuation in real time. With the valve 122 under fluid challenge, the computer directs the laser 128 to ablate the flap until the proper actuation profile is achieved. The ablation ceases when the correct actuation is achieved. If the proper actuation is not assessed, the part would be automatically rejected. In a final stage of the process, machine vision 133 is used to assure that the unloaded flat is properly refitted to its seat, completing the certification stage. The certification stage of the process may be completed with or without a valve cover on the valve assembly. If the valve cover was installed, provisions to allow the appropriate line of sight for the machine vision and areas transparent to the laser ablation beam would have to be provided for.

Employment of the method described enable continuous assembly, performance assessment, performance mitigation, and certification of valves for a wide range of critical applications. Many variations on the sequence of the operations could be envisioned. Regardless of the assembly stage approach of the method, the basic certification stage may be employed and ablation may be carried out using a variety of techniques other than laser ablation. For example, abrasion, micromachining, water jet, and the like may be used.

FIG. 14 shows a cross section of a respirator mask body 12 onto which the assembled valve may be installed. The mask body 12 may comprise multiple layers such as an inner shaping layer 17 and an outer filtration layer 18. The shaping layer 17 provides structure to the mask body 12 and support for the filtration layer 18. The shaping layer 17 may be located on the inside and/or outside of filtration layer 18 (or on both sides) and can be made, for example, from a nonwoven web of thermally-bondable fibers, molded into a cup-shaped configuration—see U.S. Pat. No. 4,807,619 to Dyrud et al. and U.S. Pat. No. 4,536,440 to Berg. It can also be made from a porous layer or an open work “fishnet” type network of flexible plastic, like the shaping layer disclosed in U.S. Pat. No. 4,850,347 to Skov. The shaping layer can be molded in accordance with known procedures such as those described in Skov or in U.S. Pat. No. 5,307,796 to Kronzer et al. Although a shaping layer 17 is designed with the primary purpose of providing structure to the mask and providing support for a filtration layer, shaping layer 17 also may act as a filter, typically for capturing larger particles. Together layers 17 and 18 may operate as an inhale filter element.

The filtration layer optionally could be corrugated as described in U.S. Pat. Nos. 5,804,295 and 5,763,078 to Braun. And the mask body 12 may also include inner and/or outer cover webs (not shown) that can protect the filter layer 18 from abrasive forces and that can retain any fibers that may come loose from the filter layer 18 and/or shaping layer 17. The cover webs also may have filtering abilities, although typically not nearly as good as the filtering layer 18 and/or may serve to make the mask more comfortable to wear. The cover webs may be made from nonwoven fibrous materials such as spun bonded fibers that contain, for example, polyolefins, and polyesters—see, for example, U.S. Pat. Nos. 6,041,782 to Angadjivand et al., 4,807,619 to Dyrud et al., and 4,536,440 to Berg.

When a wearer inhales, air is drawn through the mask body, and airborne particles become trapped in the interstices between the fibers, particularly the fibers in the filter layer 18. In the embodiment shown in FIG. 2, the filter layer 18 is integral with the mask body 12—that is, it forms part of the mask body and is not an item that subsequently becomes attached to (or removed from) the mask body like a filter cartridge.

Filtering materials that are commonplace on negative pressure half mask respirators—like the mask 10 shown in FIG. 1—often contain an entangled web of electrically charged microfibers, particularly meltblown microfibers (BMF). Microfibers typically have an average effective fiber diameter of about 20 micrometers (μm) or less, but commonly are about 1 to about 15 μm, and still more commonly be about 3 to 10 μm in diameter. Effective fiber diameter may be calculated as described in Davies, C. N., The Separation of Airborne Dust and Particles, Institution of Mechanical Engineers, London, Proceedings 1B. 1952. BMF webs can be formed as described in Wente, Van A., Superfine Thermoplastic Fibers in Industrial Engineering Chemistry, vol. 48, pages 1342 et seq. (1956) or in Report No. 4364 of the Naval Research Laboratories, published May 25, 1954, entitled Manufacture of Superfine Organic Fibers by Wente, Van A., Boone, C. D., and Fluharty, E. L. Meltblown fibrous webs can be uniformly prepared and may contain multiple layers, like the webs described in U.S. Pat. No. 6,492,286B1 and 6,139,308 to Berrigan et al. When randomly entangled in a web, BMF webs can have sufficient integrity to be handled as a mat. Electric charge can be imparted to fibrous webs using techniques described in, for example, U.S. Pat. Nos. 6,454,986B1 and 6,406,657B1 to Eitzman et al.; U.S. Pat. Nos. 6,375,886B1, 6,119,691 and 5,496,507 to Angadjivand et al., U.S. Pat. No. 4,215,682 to Kubik et al., and U.S. Pat. No. 4,592,815 to Nakao.

Examples of fibrous materials that may be used as filters in a mask body are disclosed in U.S. Pat. No. 5,706,804 to Baumann et al., U.S. Pat. No. 4,419,993 to Peterson, U.S. Reissue Pat. No. Re 28,102 to Mayhew, U.S. Pat. Nos. 5,472,481 and 5,411,576 to Jones et al., and U.S. Pat. No. 5,908,598 to Rousseau et al. The fibers may contain polymers such as polypropylene and/or poly-4-methyl-1-pentene (see U.S. Pat. Nos. 4,874,399 to Jones et al. and 6,057,256 to Dyrud et al.) and may also contain fluorine atoms and/or other additives to enhance filtration performance—see, U.S. Pat. Nos. 6,432,175B1, 6,409,806B1, 6,398,847B1, 6,397,458B1 to Jones et al. and U.S. Pat. Nos. 5,025,052 and 5,099,026 to Crater et al., and may also have low levels of extractable hydrocarbons to improve performance—see U.S. Pat. No. 6,213,122 to Rousseau et al. Fibrous webs also may be fabricated to have increased oily mist resistance as described in U.S. Pat. No. 4,874,399 to Reed et al., and in U.S. Pat. Nos. 6,238,466 and 6,068,799, both to Rousseau et al.

### EXAMPLES

### Flow Fixture

Pressure drop testing was conducted on the valve with the aid of a flow fixture. The flow fixture provided air, at specified flow rates, to the valve through an aluminum mounting plate and an affixed air plenum. The mounting plate received and securely held a valve seat during testing. The aluminum mounting plate had a slight recess on its top surface that received the valve base. Centered in the recess was a 28 millimeter (mm) by 34 mm opening through which air could flow to the valve. Adhesive-faced foam material was available to be attached to the ledge within the recess to provide an airtight seal between the valve base and the plate. Two clamps were used to capture and secure the leading and rear edge of the valve seat to the aluminum mount. Air was provided to the mounting plate through a hemispherical-shaped plenum. The mounting plate was affixed to the plenum at the top or apex of the hemisphere to mimic the cavity shape and volume of a respiratory mask. The hemispherical-shaped plenum was approximately 30 mm deep and had a base diameter of 80 mm. Air from a supply line was attached to the base of the plenum and was regulated to provide the desired flow through the flow fixture to the valve. For an established air flow, air pressure within the plenum was measured to determine the pressure drop over the test valve.

### Pressure Drop Test

Pressure drop measurements were made on a test valve using the Flow Fixture as described above. Pressure drop across a valve was measured at flow rates of 15, 20, 30, 40, 50, 60, 70, and 85 liters per minute (L/min; also represented herein as dm³/min) To test a valve, a test specimen was mounted in the Flow Fixture so that the valve seat was horizontally oriented at its base, with the valve opening facing up. Care was taken during the valve mounting to assure that there was no air bypass between the fixture and the valve body. To calibrate the pressure gauge for a given flow rate, the flap was first removed from the valve body and the desired airflow was established. The pressure gauge was then set to zero, bringing the system to calibration. After this calibration step, the flap was repositioned on the valve body and air, at the specified flow rate, was delivered to the inlet of the valve, and the pressure at the inlet was recorded. The valve-opening pressure drop (just before a zero-flow, flap opening onset point) was determined by measuring the pressure at the point where the flap just opens and a minimal flow is detected. Pressure drop was the difference between the inlet pressure to the valve and the ambient air.

### Example 1

Example 1 represents an example of a valve having an ablated flap of the present invention. The flap of the example valve was formed from an extruded sheet of 0.46 mm thick polyisoprene rubber, available from Fulflex, Inc., Brattleboro, Vt. The rubber sheet was cut into a flap in the shape shown in FIGS. 7b. The flap 44 was 17.6 mm at the narrow end 46, and 22.4 mm at the wide end 48. Length of the flap from wide to narrow end was 25 mm. The flap had two 2 mm diameter anchoring holes 59 placed on the narrow end of the flap to facilitate attachment to the flow test fixture. The holes 59 were centered 2 mm from the narrow end and sides of the flap as illustrated. An ablated hinge zone 58 was formed at the narrow end 46 of the flap. The hinge zone 58 began at the narrow end of the flap and extended 5.5 mm towards the wide end of the flap. Width of the hinge zone was 10 mm and centered from side to side on the flap. The hinge zone 58 was formed using a laser to ablate evenly spaced channels or grooves of material. The channels in the ablated zone 58 ran parallel to the width of the flap and were 10 mm long, 0.25 mm wide, and spaced 0.25 mm apart. The laser used to perform the ablation was a: 10.6 micron wavelength, Diamond E400 model, available from Coherent Inc., Santa Clara, Calif. The laser had a maximum power 600 watts (W) and operated at 50 Hz and 10% power. The flap was oriented approximately 350 mm away from the laser source and ablated at a rate of approximately 60 mm/second.

The flap as prepared was affixed to the flow fixture at its narrow end and evaluated for pressure drop at various flow rates. Results are given in Table 1.

### Example 2

Example 2 was formed and tested as Example 1 with the exception that the laser was operated at a 12% power.

### Comparative Example A

Example A represents an un-ablated control of Example 1 and 2.

TABLE 1

| | Opening | | | | | | | | | |
|---|---|---|---|---|---|---|---|---|---|---|
| | Pressure | Steady-State Flow Pressure Drop | | | | | | | | |
| | (mm | | Flow Rate (L/min) | | | | | | | |
| Example | H2O) | | 15 | 20 | 30 | 40 | 50 | 60 | 70 | 85 |
| C-A | 1.75 | Pressure | 2.3 | 2.5 | 2.7 | 2.9 | 3.4 | 4.6 | 5.7 | 7.2 |
| 1 | 1.37 | Drop (mm | 1.9 | 2.0 | 2.1 | 2.3 | 3.2 | 4.1 | 5.0 | 6.6 |
| 2 | 1.20 | H2O) | 1.7 | 1.8 | 2.0 | 2.3 | 3.3 | 4.2 | 5.3 | 6.5 |

As is illustrated by the flow testing of the examples, the valves of the invention have less resistance to opening and reduced pressure drop over the full range of flow rates as compared to the un-ablated control. Lower opening pressures and steady-state pressure drops show that it requires less work to actuate valves using properly ablated flaps. Not only does this demonstrate that ablation can be used to modify the performance of a flap valve but also in a beneficial way. The data also illustrates that by simply changing the power of the ablating laser, the actuation characteristics of the flap valve can be adjusted.

This invention may take on various modifications and alterations without departing from its spirit and scope. Accordingly, this invention is not limited to the above-described but is to be controlled by the limitations set forth in the following claims and any equivalents thereof.

This invention also may be suitably practiced in the absence of any element not specifically disclosed herein.

All patents and patent applications cited above, including those in the Background section, are incorporated by reference into this document in total. To the extent there is a conflict or discrepancy between the disclosure in such incorporated document and the above specification, the above specification will control.

What is claimed is:

1. A respirator that comprises:
(a) a mask body;
(b) a harness that is secured to the mask body; and
(c) an exhalation valve that is secured to the mask body, which exhalation valve comprises:
(i) a valve base; and
(ii) a flap that is secured to the valve base and that has a surface that has been ablated.

2. The respirator of claim 1, wherein the flap is a flexible flap.

3. The respirator of claim 2, wherein the flexible flap is mounted to the valve seat in cantilever fashion and is ablated at the hinge portion of the flexible flap.

4. The respirator of claim 2, wherein the flexible flap is ablated at the free portion of the flexible flap.

5. The respirator of claim 4, wherein the flexible flap is ablated on a first major surface of the flap.

6. The respirator of claim 5, wherein the flap is ablated 0.1 to 1 millimeter deep.

7. The respirator of claim 5, wherein the flexible flap is also ablated on a second major surface of the flap.

8. The respirator of claim 3, wherein the flexible flap is also ablated at the free portion of the flap on a first major surface.

9. The respirator of claim 2, wherein the flexible flap is secured to the valve seat centrally in button fashion, and wherein the flap is ablated in three or more regions that each extend radially from a central location on the flap.

10. The respirator of claim 9, wherein there are three ablated regions that are offset 120 degrees to each other.

11. The respirator of claim 9, wherein the ablated regions comprise a series of grooves that extend radially outward from the central location.

12. The respirator of claim 2, wherein the flexible flap is secured to the valve seat in butterfly fashion, and wherein the flap is ablated on at least one major surface of the flap at the hinge portion of the flap.

13. The respirator of claim 12, wherein the ablation at the hinge portion comprises a two or more grooves that extend generally parallel to each other and to the axis of rotation.

14. The respirator of claim 3, wherein the ablation at the hinge portion comprises a two or more grooves that extend generally parallel to each other and to the axis of rotation.

15. A method of making a respirator, which method comprises:
(a) providing a valve base and a mask body;
(b) securing an ablated flap to the valve base; and
(c) securing the valve base to the mask body.

16. The method of claim 15, wherein the flap is ablated prior to securing the flap to the valve seat.

17. The method of claim 15, wherein the flap is ablated after securing the flap to the valve seat.

18. The method of claim 15, further comprising quality checking valve performance.

19. The method of claim 18, further comprising further ablating the flap material following the quality check step.

20. The method of claim 15, wherein the flap is ablated at the hinge portion of the flap.
